(19) United States
(12) Patent Application Publication
(10) Pub. No.: US 2024/0295659 A1
(43) Pub. Date: Sep. 5, 2024

(54) METHOD, DEVICE, APPARATUS, AND STORAGE MEDIUM FOR IDENTIFYING TYPE OF ATMOSPHERIC AEROSOL

(71) Applicant: Anhui Meteorological Science Research Institute, Hefei City (CN)

(72) Inventors: Zhuang WANG, Hefei City (CN); Hao ZHANG, Hefei City (CN); Chun'e SHI, Hefei City (CN); Caixia YU, Hefei City (CN); Jing ZHAI, Hefei City (CN); Guanying YANG, Hefei City (CN)

(21) Appl. No.: 18/407,890

(22) Filed: Jan. 9, 2024

(30) Foreign Application Priority Data
Mar. 2, 2023 (CN) 202310215601.3

(51) Int. Cl. G01S 17/95; G01S 7/499

(52) U.S. Cl. CPC G01S 17/95; G01S 7/499

(57) ABSTRACT

The disclosure provides a method, a device, an apparatus, and a storage medium for identifying a type of atmospheric aerosol. The method includes: determining a depolarization ratio and an aerosol extinction coefficient of an atmospheric area to be identified according to a lidar signal and a relative humidity profile of the area; identifying a cloud type of the area according to the signal and the profile; and identifying a type of an atmospheric aerosol in the area based on the cloud type, the ratio and the coefficient. Relevant values are calculated based on lidar signals and the profile, clouds are identified first, and then different types of aerosols are further distinguished in combination with the relevant values, and a numerical determination standard is given to synchronously identify different types of aerosols including types of cloud, fog and other particulates in the atmosphere, thereby improving accuracy of identification.

### CROSS-REFERENCE TO RELATED APPLICATION

This patent application claims the benefit and priority of Chinese Patent Application No. 202310215601.3 filed with the China National Intellectual Property Administration on Mar. 2, 2023, the disclosure of which is incorporated by reference herein in its entirety as part of the present application.

### TECHNICAL FIELD

The present disclosure relates to the technical field of atmospheric environment detection, in particular to a method, a device, an apparatus, and a storage medium for identifying a type of an atmospheric aerosol.

### BACKGROUND

Different atmospheric aerosol particulates play a key role in influencing an earth climate system by direct action such as absorbing and scattering solar radiation. The shape, size distribution and chemical composition of aerosols will lead to different optical properties of aerosols, and further have different effects on climate. Accurate identification of a type of the aerosol is helpful to determine aerosol emission sources and deeply understand the long-distance transmission process of the aerosol, thus providing scientific reference for the implementation of control policies. Therefore, identifying a type of the aerosol is of great significance in the fields of atmosphere, environment and remote sensing science.

At present, researchers have established many aerosol classification solutions by using different aerosol optical parameters. However, these aerosol classification solutions need a lot of complicated operations and it is difficult to accurately distinguish various types of aerosols existing in the atmosphere.

The above contents are intended to assist in understanding the technical solution of the present disclosure, and do not imply an admission of the relevant technologies.

### SUMMARY

The main objective of the present disclosure is to provide a method, a device, an apparatus, and a storage medium for identifying a type of an atmospheric aerosol, aiming at solving the technical problems in the prior art that it is difficult to quickly and accurately distinguish a plurality of different types of aerosols in the atmosphere.

In order to achieve the above purpose, the present disclosure provides a method for identifying a type of an atmospheric aerosol, the method includes:
determining a depolarization ratio and an aerosol extinction coefficient of an atmospheric area to be identified according to a lidar signal and a relative humidity profile of the atmospheric area to be identified;
identifying a cloud type of the atmospheric area to be identified according to the lidar signal and the relative humidity profile; and
identifying a type of the atmospheric aerosol in the atmospheric area to be identified based on the cloud type, the depolarization ratio and the aerosol extinction coefficient.

Optionally, identifying the type of atmospheric aerosol in the atmospheric area to be identified based on the cloud type, the depolarization ratio and the aerosol extinction coefficient includes:
identifying a fog type of the atmospheric area to be identified according to the aerosol extinction coefficient when the cloud type is a cloudless type; and
identifying the type of the atmospheric aerosol in the atmospheric area to be identified based on the fog type and the depolarization ratio.

Optionally, the depolarization ratio is a particulate depolarization ratio, and identifying the type of the atmospheric aerosol in the atmospheric area to be identified based on the fog type and the depolarization ratio includes:
comparing the particulate depolarization ratio with a preset first particulate standard value when the fog type is a fogless type; and
determining that the type of the atmospheric aerosol in the atmospheric area to be identified is a dust aerosol when the depolarization ratio of the atmospheric area is greater than the preset first particulate standard value.

Optionally, after comparing the particulate depolarization ratio with the preset first particulate standard value when the fog type is the fogless type, the method includes:
comparing the particulate depolarization ratio with a preset second particulate standard value when the particulate depolarization ratio is less than or equal to the preset first particulate standard value; and
determining that the type of the atmospheric aerosol in the atmospheric area to be identified is a mixed aerosol when the particulate depolarization ratio is greater than the preset second particulate standard value; or
determining that the type of the atmospheric aerosol in the atmospheric area to be identified is an artificially polluted aerosol when the particulate depolarization ratio is less than or equal to the preset second particulate standard value.

Optionally, after identifying the type of the atmospheric aerosol in the atmospheric area to be identified based on the fog type and the depolarization ratio, the method includes:
when the type of atmospheric aerosol is determined to be a particulate type, inverting a mass concentration profile of the particulate-type aerosol in the atmospheric area according to the aerosol extinction coefficient of the atmospheric area to be identified.

Optionally, identifying the fog type of the atmospheric area to be identified according to the aerosol extinction coefficient when the cloud type is the cloudless type includes:
determining whether the atmospheric area is a foggy type according to the relative humidity profile when the cloud type is the cloudless type;
comparing the aerosol extinction coefficient with a preset first fog concentration standard value when the atmospheric area is the foggy type; and
determining that the fog type of the atmospheric area to be identified is a dense fog type when the aerosol extinction coefficient is greater than the preset first fog concentration standard value; or
determining that the fog type of the atmospheric area to be identified is a mist type when the aerosol extinction coefficient is less than or equal to the preset first fog concentration standard value.

Optionally, the depolarization ratio is an atmospheric volume depolarization ratio, and after identifying the cloud type of the atmospheric area to be identified according to the lidar signal and the relative humidity profile, the method further includes:
comparing the atmospheric volume depolarization ratio with a preset atmospheric volume standard value when the cloud type is a cloudy type; and
determining that the cloud type of the atmospheric area to be identified is an ice cloud type when the atmospheric volume depolarization ratio is greater than the preset atmospheric volume standard value; or
determining that the cloud type of the atmospheric area to be identified is a water cloud type when the atmospheric volume depolarization ratio is less than or equal to the preset atmospheric volume standard value.

In addition, in order to achieve the above purpose, the present disclosure further provides an apparatus for identifying a type of an atmospheric aerosol, wherein the apparatus includes:
a depolarization ratio determining module, configured to determine a depolarization ratio and an aerosol extinction coefficient of an atmospheric area to be identified according to a lidar signal and a relative humidity profile of the atmospheric area to be identified;
a cloud type identifying module, configured to identify a cloud type of the atmospheric area to be identified according to the lidar signal and the relative humidity profile; and
an aerosol identifying module, configured to identify the type of the atmospheric aerosol in the atmospheric area to be identified based on the cloud type, the depolarization ratio and the aerosol extinction coefficient.

In addition, in order to achieve the above purpose, the present disclosure further provides a device for identifying a type of an atmospheric aerosol, wherein the device includes a memory, a processor, and a program for identifying a type of an atmospheric aerosol stored in the memory and operable on the processor, wherein the program for identifying the type of atmospheric aerosol is configured to implement the method for identifying the type of the atmospheric aerosol as described above.

In addition, in order to achieve the above purpose, the present disclosure further provides a storage medium, where a program for identifying a type of an atmospheric aerosol is stored in the storage medium, and when being executed by a processor, the program for identifying the type of the atmospheric aerosol implements the method for identifying the type of the atmospheric aerosol as described above.

According to the present disclosure, the method includes: first, determining a depolarization ratio and an aerosol extinction coefficient of an atmospheric area to be identified according to a lidar signal and a relative humidity profile of the atmospheric area to be identified; identifying a cloud type of the atmospheric area to be identified according to the lidar signal and the relative humidity profile; and identifying a type of an atmospheric aerosol in the atmospheric area to be identified based on the cloud type, the depolarization ratio and the aerosol extinction coefficient. According to the present disclosure, relevant data values of the area for subsequently distinguishing types of aerosol are calculated based on signals acquired by lidar in combination with the atmospheric relative humidity profile of the area, clouds in the area are identified first, and then different types of aerosols are further distinguished in combination with the calculated relevant data values, so that a plurality of different types of aerosols including types of clouds, fog and other particulates in the atmosphere can be synchronously identified, and a numerical determination standard is given, thereby improving accuracy of identifying the type of the aerosol.

### BRIEF DESCRIPTION OF THE DRAWINGS

FIG. 1 is a schematic structural diagram of a method and a device for identifying a type of an atmospheric aerosol in a hardware operation environment according to an embodiment of the present disclosure.

FIG. 2 is a schematic flow chart of a first embodiment of a method for identifying a type of an atmospheric aerosol according to the present disclosure.

FIG. 3 is a schematic flow chart of a second embodiment of a method for identifying a type of an atmospheric aerosol according to the present disclosure.

FIG. 4 is a schematic flow chart of a third embodiment of a method for identifying a type of an atmospheric aerosol according to the present disclosure.

FIG. 5 is a structural block diagram of a first embodiment of an apparatus for identifying a type of an atmospheric aerosol according to the present disclosure.

The implementation, functional characteristics and advantages of the present disclosure will be further described with reference to the drawings in combination with embodiments.

### DETAILED DESCRIPTION OF THE EMBODIMENTS

It should be understood that the specific embodiments described here are only used to explain the present disclosure, rather than limit the present disclosure.

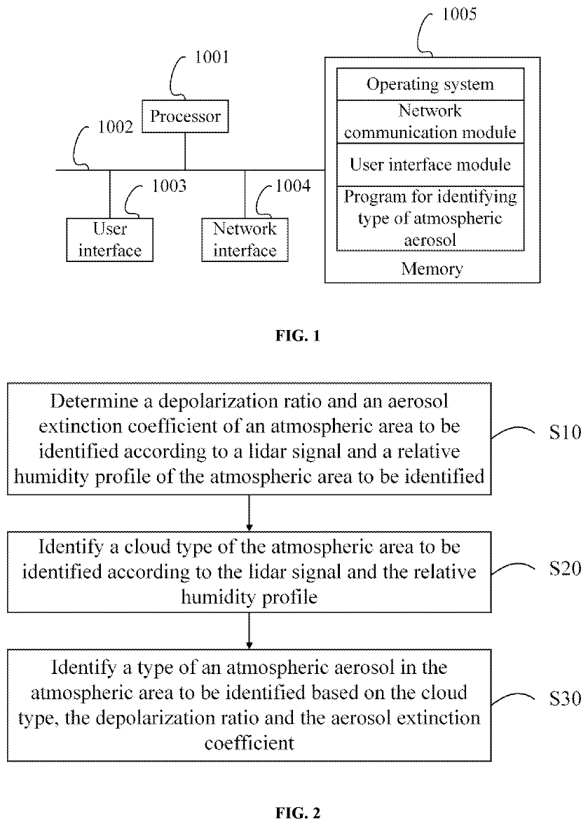

Referring to FIG. 1, FIG. 1 is a schematic structural diagram of a device for identifying a type of an atmospheric aerosol in a hardware operating environment according to an embodiment of the present disclosure.

As shown in FIG. 1, the device for identifying the type of the atmospheric aerosol may include a processor 1001, such as a Central Processing Unit (CPU), a communication bus 1002, a user interface 1003, a network interface 1004, and a memory 1005. The communication bus 1002 is configured to realize connection communication between these components. The user interface 1003 may include a display and an input unit such as a keyboard. The user interface 1003 may also optionally include a standard wired interface and a wireless interface. The network interface 1004 may optionally include a standard wired interface and a wireless interface (such as a Wireless-Fidelity (Wi-Fi) interface). The memory 1005 may be a high-speed Random Access Memory (RAM) or a stable Non-Volatile Memory (NVM), such as a disk memory. The memory 1005 may optionally be a storage device independent of the processor 1001 described above.

It can be understood by those skilled in the art that the structure shown in FIG. 1 does not constitute a limitation on the device for identifying the type of atmospheric aerosol, and may include more or less components than shown, or combine some components, or have different component arrangements.

As shown in FIG. 1, the memory 1005 as a storage medium may include an operating system, a network communication module, a user interface module and a program for identifying the type of the atmospheric aerosol.

In the device for identifying the type of atmospheric aerosol shown in FIG. 1, the network interface 1004 is mainly configured to perform data communication with the network server. The user interface 1003 is mainly configured to perform data interaction with users. The processor 1001 and the memory 1005 in the device for identifying the type of the atmospheric aerosol of the present disclosure can be arranged in the device for identifying the type of the atmospheric aerosol. The device for identifying the type of the atmospheric aerosol calls the program for identifying the type of the atmospheric aerosol stored in the memory 1005 through the processor 1001 and executes the method for identifying the type of the atmospheric aerosol provided by the embodiment of the present disclosure.

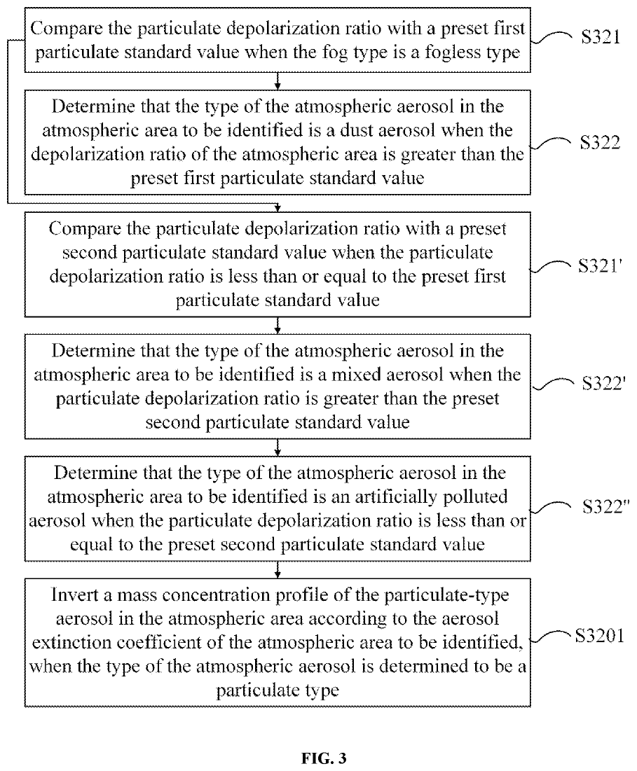

The embodiment of the present disclosure provides a method for identifying a type of an atmospheric aerosol. Referring to FIG. 2, FIG. 2 is a schematic flow chart of a first embodiment of a method for identifying a type of an atmospheric aerosol according to the present disclosure.

In this embodiment, the method for identifying the type of atmospheric aerosol includes the steps S10-S30.

Step S10: a depolarization ratio and an aerosol extinction coefficient of an atmospheric area to be identified are determined according to a lidar signal and a relative humidity profile of the atmospheric area to be identified.

It should be noted that the execution subject of the method in this embodiment can be a computer service device with data processing, network communication and program running functions, such as a mobile phone, a tablet computer, a smart bracelet, a personal computer, etc., and can also be other electronic devices that can realize the same or similar functions, which is not limited in this embodiment. Hereinafter, embodiments of the method for identifying the type of atmospheric aerosol of the present disclosure will be described by taking the device for identifying the type of the atmospheric aerosol (hereinafter referred to as an aerosol identifying device) as an example.

It should be noted that the lidar can be a polarized lidar, and the data acquired by the polarized lidar can be used to calculate the atmospheric extinction coefficient, atmospheric depolarization ratio and other relevant data about the atmosphere in the area so as to further distinguish different types of aerosols in the area. The temporal resolution and the spatial resolution of polarized lidar can meet the requirements of detecting types of aerosols with high temporal and spatial resolution, and the aerosol profile data of this type can be further inverted after the type of the aerosol is determined.

It can be understood that the inversion of polarized lidar data requires a meteorological parameter (temperature, humidity and pressure) with high temporal and spatial resolution, and the profile of the meteorological parameter limits the inversion accuracy of lidar data. The meteorological parameter with high temporal and spatial resolution is an important basis for identifying clouds and fog in the atmosphere.

It should be noted that the relative humidity profile is a meteorological parameter with high temporal and spatial resolution. The relative humidity profile of the atmospheric area to be identified can be acquired by the microwave radiometer. The microwave radiometer is a high-sensitivity receiving device which can determine the temperature and humidity curves by passively receiving microwave signals of temperature radiation from various heights, and can quantitatively measure the low-level microwave radiation of targets (such as ground objects and atmospheric components). In this embodiment, the microwave radiometer is selected to cooperate with the polarized laser for observation, which can take into account factors such as atmospheric temperature, pressure and relative humidity so that the calculated relevant parameters of the atmospheric area to be identified are more accurate.

It should be understood that the depolarization ratio, that is, the ratio of depolarization, is the ratio of the polarization ratio of the scattered electromagnetic waves to the fully polarized waves after the polarized electromagnetic waves irradiate the precipitation particulates. The depolarization ratio is a parameter that can directly reflect the shape of aerosol particulates. The larger the depolarization ratio, the more irregular the particulate shape is. The atmospheric depolarization ratio of the area to be identified can be the atmospheric volume depolarization ratio, the aerosol (particulate) depolarization ratio or the atmospheric molecular depolarization ratio. The atmospheric volume depolarization ratio of this area is the sum of the aerosol depolarization ratio and the atmospheric molecular depolarization ratio, and the atmospheric molecular depolarization ratio can be regarded as a constant.

It can be understood that the extinction coefficient is the light absorption value of the measured solution. If the measured solution has a high concentration, the solution has, after color development, dark color, large light absorption, and low light transmittance, and vice versa. The extinction coefficient of the atmospheric aerosol reflects its extinction characteristics, and then can reflect atmospheric environmental quality problems such as transmittance and visibility.

It should be understood that after acquiring the lidar signal data, the aerosol extinction coefficient can usually be calculated and inverted by using Klett inversion algorithm or Fermald algorithm, which is not limited in this embodiment. The Fermald algorithm is selected here to explain this embodiment and the following embodiments.

In the specific implementation, the aerosol identifying device acquires the backscattered signal of the polarized lidar and the relative humidity profile observed by the microwave radiometer, inverses the profiles of the atmospheric volume depolarization ratio, the (particulate) aerosol depolarization ratio and the aerosol extinction coefficient, and obtains the aerosol extinction coefficient by using the backward model of the Fermald algorithm.

The calculation formula of the atmospheric volume depolarization ratio can be as follows:

$$V D R = η \frac{{P}_{sig}^{⊥}}{{P}_{sig}^{□}} ,$$

where VDR is an atmospheric volume depolarization ratio, P_{sig}^{⊥} and P_{sig}^{□} are backscattered signals of lidar of a vertical channel and a parallel channel, respectively, and η is a correction coefficient.

It can be understood that because the atmospheric volume depolarization ratio is closely related to atmospheric molecules and aerosol, the atmospheric volume depolarization ratio directly depends on the ratio of the backscattered signal in the vertical channel to the backscattered signal in the parallel channel, and it is not necessary to assume the reference height and calculate the aerosol extinction coefficient.

Further, the calculation formula of the particulate depolarization ratio can be as follows:

$$P D {R}_{a e r} = \frac{{β}_{m o l} ( V D R - P D {R}_{m o l} ) + {β}_{a e r} V D R ( 1 + P D {R}_{m o l} )}{{β}_{m o l} ( P D {R}_{m o l} - V D R ) + {β}_{a e r} ( 1 + P D {R}_{m o l} )} ,$$

where PDRₐₑᵣ is a (particulate) aerosol depolarization ratio, PDRₘₒₗ is an atmospheric molecular depolarization ratio which is usually 0.014, βₐₑᵣ is an aerosol backscattering coefficient, and βₘₒₗ is an atmospheric molecular backscattering coefficient.

Step S20: a cloud type of the atmospheric area to be identified is identified according to the lidar signal and the relative humidity profile.

It should be understood that the cloud type of the atmospheric area to be identified can include a cloudy type and a cloudless type, and cloud detection can be carried out based on the backscattered signal of lidar and the relative humidity profile of the microwave radiometer to determine whether there are clouds in this area.

It should be noted that the cloud detection method can be as follows: first, the cloud bottom and the cloud top are determined, and the derivative of the distance of the backscattered signal of lidar after the distance square correction, is calculated first. When the derivative value is greater than the first threshold for the first time, the corresponding height is the cloud bottom. When the derivative value is less than the second threshold for the last time, the corresponding height is the cloud top. The first threshold and the second threshold are empirical values, and the empirical values can be set based on lidars of different models, which is not limited by this embodiment. Then, after the cloud bottom or the cloud top is determined, it is determined whether there may be multiple layers of clouds in this range. Finally, it is determined, in combination with the relative humidity profile, that the current area is the area of the cloudy type when the relative humidity is greater than a preset humidity threshold, wherein the preset humidity threshold can be set to 90% or a percentage higher or lower than this value based on the specific climate characteristics of the atmospheric area to be identified, which is not limited by this embodiment.

Step S30: a type of an atmospheric aerosol in the atmospheric area to be identified is identified based on the cloud type, the depolarization ratio and the aerosol extinction coefficient.

Further, in order to further distinguish the fog influence in the atmosphere area to be identified where the cloud influence can be distinguished, step S30 includes:

Step S31: identifying a fog type of the atmospheric area to be identified according to the aerosol extinction coefficient when the cloud type is a cloudless type; and

Step S32: identifying the type of the atmospheric aerosol in the atmospheric area to be identified based on the fog type and the depolarization ratio.

When the cloud type of the area to be identified is a cloudless type, it can be first determined, for the cloudless area, whether the aerosol extinction value of the area is missing. If it is missing, the atmospheric area is marked as “data missing”. If it is not missing, in the case that the aerosol extinction coefficient of the area to be identified can be acquired, the aerosol extinction coefficient is compared with the preset cleaning standard value; if the acquired aerosol extinction coefficient value is less than or equal to the preset cleaning standard value, the atmospheric area is marked as “clean”, wherein the preset cleaning standard value can be set to 0.05 km⁻¹ or other values, which is not limited by this embodiment.

It should be understood that when the acquired aerosol extinction coefficient value is greater than the preset cleaning standard value, the fog type of the atmospheric area to be identified can be identified according to the aerosol extinction coefficient, and then the type of the atmospheric aerosol in the atmospheric area to be identified can be further distinguished based on the fog type of the atmospheric area and the atmospheric depolarization ratio.

It should be noted that aerosol refers to a gaseous dispersion system consisted of solid or liquid particulates suspended in a gas medium, and the density of these solid or liquid particulates can be slightly different or greatly different from that of the gas medium. Clouds and fog in the sky also belong to aerosol.

It should be understood that the atmospheric aerosol, also known as a particulate, refers to a liquid or solid particulate suspended in the atmosphere (generally excluding clouds and fog), which is a pollutant with huge quantity, complex composition, diverse properties and the greatest harm in urban atmosphere. The shape, the size distribution and the chemical composition of aerosol will lead to different optical properties of aerosol, and then have different effects on climate. Particulates can be divided into natural sources and artificial sources according to their sources. Natural source aerosol, such as dust aerosol, is usually a large particulate with scattering tendency. However, artificial aerosol, such as artificially polluted aerosol, is usually a small particulate with absorption properties. In addition, according to the formation mechanism, particulates can be divided into primary particulates and secondary particulates. Atmospheric particulates influence the exchange of an earth-atmosphere system by absorbing and scattering solar radiation, and then influence the climate system.

In specific implementation, when the cloud type of the area to be identified is a cloudless type, the aerosol identifying device determines whether the aerosol extinction coefficient is missing. When the aerosol extinction coefficient can be acquired, the acquired value is compared with the preset value of the cleaning standard to determine whether the atmospheric area to be identified is a clean area, and then the fog type of the area can be determined in combination with the relative humidity acquired by the microwave radiometer when it is determined to be a non-clean area. Finally, in combination with the atmospheric volume depolarization ratio, the particulate depolarization ratio and the aerosol extinction coefficient calculated based on the polarization lidar signal and the relative humidity profile, the type of the atmospheric aerosol except clouds and fog in the atmosphere are further identified and distinguished, which improves the speed and accuracy of identifying different aerosols in the atmosphere.

In this embodiment, a depolarization ratio and an aerosol extinction coefficient of an atmospheric area to be identified are determined according to a lidar signal and a relative humidity profile of the atmospheric area to be identified; and thereafter, a cloud type of the atmospheric area to be identified is identified according to the lidar signal and the relative humidity profile, and then a type of an atmospheric aerosol is identified in the atmospheric area to be identified based on the cloud type, the depolarization ratio and the aerosol extinction coefficient. According to this embodiment, since a microwave radiometer is introduced while the polarized lidar is used for observation, the atmospheric temperature, the pressure, the relative humidity and the aerosol optical parameter profile can be measured synchronously, and parameter values for subsequently distinguishing various aerosols are calculated based on the lidar signal and the relative humidity profile. According to the comparison result between the parameter values and the preset reference values, the area where the atmospheric area to be identified is a cloud type is first identified. Then, the situation that the data is missing and the area is a clean area is ruled out, and the area where the atmospheric area to be identified is the fog type is identified. Finally, the type of the atmospheric aerosol except clouds and fog in the atmosphere is further identified and distinguished, so that a plurality of different types of aerosols including types of clouds, fog and other particulates in the atmosphere can be synchronously identified, and given a numerical determination standard to improve the accuracy of identifying the type of the aerosol.

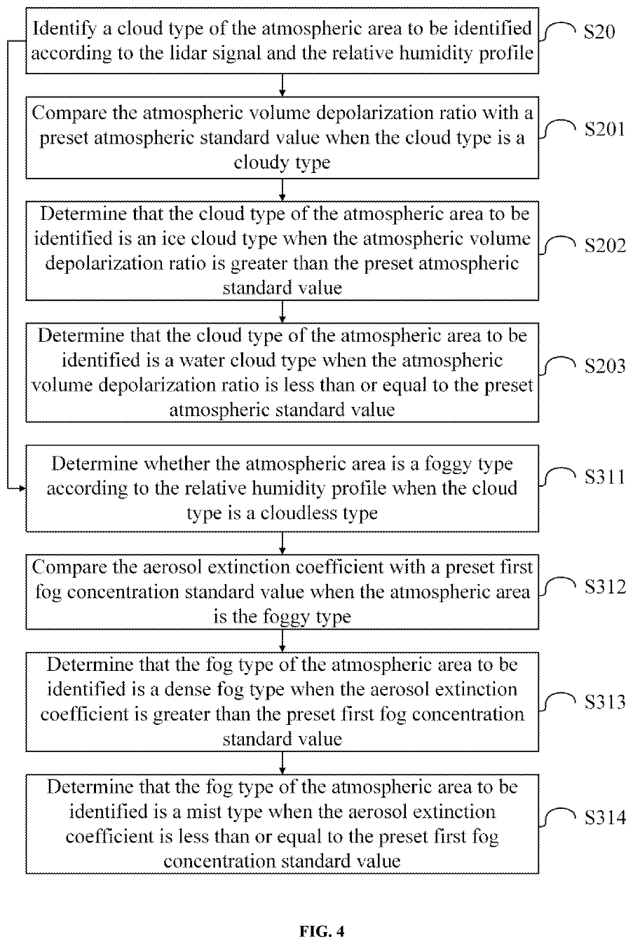

Referring to FIG. 3, FIG. 3 is a schematic flow chart of a second embodiment of a method for identifying a type of an atmospheric aerosol according to the present disclosure.

Based on the above-mentioned first embodiment, in this embodiment, in order to further identify natural source aerosols, such as dust aerosols, in the atmosphere, when distinguishing the influence of clouds and fog, step S32 includes steps S321 and S322.

Step S321: the particulate depolarization ratio is compared with a preset first particulate standard value when the fog type is a fogless type.

It can be understood that the depolarization ratio is a parameter that can directly reflect the shape of aerosol particulates. The larger the depolarization ratio is, the more irregular the particulate shape is. Particulates can be divided into natural sources and artificial sources according to their sources. Aerosol from the natural source, such as the dust aerosol, usually has a large particulate, while the aerosol from the artificial source, such as the artificially polluted aerosol, usually has a small particulate.

Step S322: it is determined that the type of atmospheric aerosol in the atmospheric area to be identified is the dust aerosol when the depolarization ratio of the atmospheric area is greater than the preset first particulate standard value.

It should be noted that, in this embodiment, the first particulate standard value can be a preset threshold value based on the empirical value, which is used to divide the above-mentioned different types of particulate aerosols according to the particulate depolarization ratio in the atmospheric area to be identified calculated in the previous steps. The first particulate standard value can be used to directly distinguish the dust aerosol. Here, the first particulate standard value can be preset as 0.3 to explain this embodiment and the following embodiments.

It should be understood that when it is determined that the atmospheric area to be identified is not a foggy type, that is, a fogless type, the calculated particulate depolarization ratio is acquired. If the particulate depolarization ratio is greater than 0.3, the type of the atmospheric aerosol in this area is marked as the dust aerosol.

It can be understood that when distinguishing the influence of clouds and fog on the type of the atmospheric aerosol in the atmospheric area to be identified, that is, determining that the area to be identified is a particulate aerosol, whether there is the natural source aerosol such as the dust aerosol in the current atmospheric area to be identified may be directly determined by setting the first particulate standard value, which improves the speed of identifying the atmospheric area belonging to the dust aerosol type.

Further, in order to further distinguish the type of the atmospheric aerosol other than the dust type, after step S321, the method further includes steps S321′ and S322′.

Step S321′: the particulate depolarization ratio is compared with a preset second particulate standard value when the particulate depolarization ratio is less than or equal to the preset first particulate standard value.

It should be noted that, in this embodiment, the second particulate standard value can be a preset threshold value based on the empirical value, which is used to divide the above-mentioned different types of particulate aerosols according to the particulate depolarization ratio in the atmospheric area to be identified calculated in the previous steps. The second particulate standard value can be used to directly distinguish the mixed aerosol from the artificially polluted aerosol in the atmospheric aerosol of a non-dust type. Here, the second standard value can be preset as 0.1 to explain this embodiment and the following embodiments.

Step S322′: it is determined that the type of the atmospheric aerosol in the atmospheric area to be identified is a mixed aerosol when the particulate depolarization ratio is greater than the preset second particulate standard value.

It can be understood that the mixed aerosol includes the dust aerosol and the artificially polluted aerosol, and the particulate size is between the dust aerosol and the artificially polluted aerosol.

Step S322″: it is determined that the type of the atmospheric aerosol in the atmospheric area to be identified is the artificially polluted aerosol when the particulate depolarization ratio is less than or equal to the preset second particulate standard value.

It should be understood that when it is determined that the atmospheric area to be identified is not the dust aerosol type, the particulate depolarization ratio calculated above is further compared with the second particulate standard value of 0.1. If the particulate depolarization ratio is greater than 0.1, the type of the atmospheric aerosol in this area is marked as the mixed aerosol. If the particulate depolarization ratio is less than or equal to 0.1, the type of the atmospheric aerosol in this area is marked as the artificially polluted aerosol.

It can be understood that the first particulate standard value is set, so that the type of the atmospheric aerosol in the atmospheric area that is not the dust aerosol type can be further distinguished between the mixed aerosol and the artificially polluted aerosol, which is more conducive to subsequently proposing targeted control measures based on a plurality of different types of aerosols.

In the specific implementation, when it is determined that the atmospheric area to be identified is not a foggy type, the particulate depolarization ratio calculated above is acquired in the embodiment. If the particulate depolarization ratio is greater than 0.3, the type of the atmospheric aerosol in this area is marked as the dust aerosol. If the particulate depolarization ratio is less than 0.1, the type of the atmospheric aerosol in this area is marked as the artificially polluted aerosol. If the particulate depolarization ratio is between 0.1 and 0.3, the type of the atmospheric aerosol in this area is marked as the mixed aerosol.

Further, in order to acquire the mass of the particulate aerosol for further analysis of different types of atmospheric aerosols, after step S32, the method may further include step S3201.

Step S3201: when the type of atmospheric aerosol is determined to be a particulate type, a mass concentration profile of the particulate-type aerosol in the atmospheric area is inverted according to the aerosol extinction coefficient of the atmospheric area to be identified.

It should be noted that the inversion formula of aerosol mass concentration can be: m=ρ×ν×α, where m represents the mass concentration of the dust or artificially polluted aerosol, ρ represents the particulate density of the dust or artificially polluted aerosol, wherein the particulate densities of dust and artificial pollutants are 2.6±0.6 g/cm³ and 1.5±0.3 g/cm³, respectively, and ν represents the conversion coefficient of the dust or artificially polluted aerosol which can be estimated by the observation results of a sun-photometer or can be set as a value based on empirical values, and α represents the extinction coefficient of the dust or artificially polluted aerosol.

Further, the mixed aerosol includes the dust aerosol and the artificially polluted aerosol. The extinction coefficient separation of dust and artificial pollutants in the mixed aerosol first needs to assume that the aerosol is externally mixed, so as to further separate the contribution of dust and artificially polluted aerosols in the mixed aerosol to the total extinction coefficient. The formula for calculating the extinction coefficient of the dust aerosol can be

$${α}_{d} = {s}_{d} {β}_{a e r} \frac{( P D {R}_{a e r} - 0.1 ) ( 1 + 0.3 )}{( 0.3 - 0.1 ) ( 1 + P D {R}_{a e r} )} ,$$

where α_{d} is the extinction coefficient of the dust aerosol, S_{d} is the radar ratio of the dust aerosol which is generally 43sr, and βₐₑᵣ is the backscattering coefficient of the aerosol. The formula for calculating the extinction coefficient of the artificially polluted aerosol is:

$${α}_{a} = {s}_{a} ( {β}_{a e r} - {β}_{a e r} \frac{( P D {R}_{a e r} - 0.1 ) ( 1 + 0.3 )}{( 0.3 - 0.1 ) ( 1 + P D {R}_{a e r} )} ) ,$$

where αₐ is the extinction coefficient of the artificially polluted aerosol, and sₐ is a radar ratio of the artificially polluted aerosol which is generally 56sr.

In the specific implementation, after the extinction coefficients of the dust and artificially polluted aerosols in the mixed aerosol are separate, the mass concentrations of the dust and artificially polluted aerosols are inverted. Through the calculation of the inversion formula of the aerosol mass concentration, when the atmospheric area to be identified is the dust aerosol or the artificially polluted aerosol, the mass concentration profiles of (particulate) aerosols in the area can be acquired, respectively; when the atmospheric area to be identified is the mixed aerosol, the mass concentration profiles of the dust aerosol and the artificially polluted aerosol in this area can be acquired, which is conducive to further monitoring and analysis of different types of (particulate) aerosols in the current atmospheric area.

In this embodiment, when it is determined that the atmospheric area to be identified is a non-cloud type area and a non-fog type area, in combination with the above-mentioned particulate depolarization ratio calculated based on the lidar signal and the relative humidity profile for distinguishing various aerosols, the depolarization ratio is compared with the preset particulate standard value. The dust aerosol, artificially polluted aerosol and the mixed aerosol are distinguished based on different comparison results, which can accurately distinguish whether the atmospheric particulate aerosol is a natural source aerosol or an artificial source aerosol on the premise of distinguishing the influence of clouds and fog, and further invert the mass concentration profiles of different types of (particulate) aerosols. This will help to determine the aerosol emission sources, deeply understand the long-distance transmission process of aerosols, and thus provide scientific basis for the implementation of control policies.

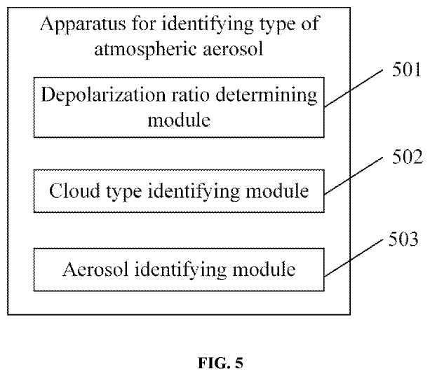

Referring to FIG. 4, FIG. 4 is a schematic flow chart of a third embodiment of a method for identifying a type of an atmospheric aerosol according to the present disclosure.

Based on the above-mentioned embodiment, in this embodiment, in order to further distinguish the atmospheric area to be identified which has been determined as a cloud type, after step S20, the method includes steps S201-S203.

Step S201: the atmospheric volume depolarization ratio is compared with a preset atmospheric volume standard value when the cloud type is a cloudy type.

It should be noted that the preset atmospheric volume standard value can be a preset threshold value based on the empirical value, which is used to divide different cloud types according to the atmospheric volume depolarization ratio in the atmospheric area to be identified calculated in the previous steps. The different cloud types are ice clouds and water clouds, which is not limited by this embodiment. Here, the atmospheric volume standard value can be preset as 0.15 to explain this embodiment and the following embodiments.

Step S202: it is determined that the cloud type of the atmospheric area to be identified is an ice cloud type when the atmospheric volume depolarization ratio is greater than the preset atmospheric volume standard value.

Step S203: it is determined that the cloud type of the atmospheric area to be identified is a water cloud type when the atmospheric volume depolarization ratio is less than or equal to the preset atmospheric volume standard value.

In the specific implementation, when it is determined that the atmosphere to be identified is the cloudy type, the calculated atmospheric volume depolarization ratio is acquired. If the atmospheric volume depolarization ratio is greater than 0.15, the cloud type of the atmospheric area to be identified is the ice cloud. If the atmospheric volume depolarization ratio is less than or equal to 0.15, the cloud type of the atmospheric area to be identified is marked as the water cloud.

It can be understood that the atmospheric volume standard value is preset to distinguish the ice cloud from the water cloud in the atmospheric area to be identified which has been determined to be the cloudy type, which can provide a deeper understanding of the source of the atmospheric aerosol in the current area, and reflect the climate characteristics of the current atmospheric area, thereby better studying and protecting the environment where the atmospheric area to be identified is located.

Further, in order to further distinguish the atmospheric area to be identified which has been determined as a fog type, step S31 includes steps S311-S314.

Step S311: it is determined whether the atmospheric area is the foggy type according to the relative humidity profile when the cloud type is the cloudless type.

It should be noted that a humidity threshold can be preset to be compared with the relative humidity profile of the area to be identified based on the observation of the microwave radiometer, so as to determine whether the area is the foggy type. The preset humidity threshold can be set as 90% or a percentage higher or lower than this value based on the specific climate characteristics of the atmospheric area to be identified, which is not limited by this embodiment.

Step S312: the aerosol extinction coefficient is compared with a preset first fog concentration standard value when the atmospheric area is a foggy type.

It should be noted that the preset first fog concentration standard value can be a preset threshold value based on the empirical value, for the aerosol extinction coefficient of the atmospheric area to be identified that is calculated according to the previous steps, which is not limited by this embodiment. Here, the preset first fog concentration standard value can be preset as 1.5 km⁻¹ to explain this embodiment and the following embodiments.

Step S313: it is determined that the fog type of the atmospheric area to be identified is a dense fog type when the aerosol extinction coefficient is greater than the preset first fog concentration standard value.

Step S314: it is determined that the fog type of the atmospheric area to be identified is a mist type when the aerosol extinction coefficient is less than or equal to the preset first fog concentration standard value.

In the specific implementation, when it is determined that the atmosphere to be identified is the foggy type, the aerosol extinction coefficient calculated above is acquired. If the aerosol extinction coefficient is greater than 1.5 km⁻¹, the fog type of the atmospheric area to be identified is marked as dense fog. If the aerosol extinction coefficient is less than or equal to 1.5 km⁻¹, the fog type of the atmospheric area to be identified is marked as mist.

It can be understood that the fog concentration standard value is preset to distinguish the dense fog from the mist in the atmospheric area to be identified which has been determined as the foggy type, which can better determine the cause of the aerosol type to which the current area belongs and whether there is environmental pollution and pollution severity in the current area reflected by the aerosol type, and then use more targeted prevention and control policies.

In this embodiment, when it is determined that the atmospheric area to be identified is an area of a cloud type or a fog type, different cloud types can be further distinguished from ice clouds and water clouds, and different fog types can be distinguished from dense fog and mist in combination with the atmospheric volume depolarization ratio and the aerosol extinction coefficient for distinguishing a plurality types of aerosols which is calculated based on the lidar signal and the relative humidity profile, thus improving the identification accuracy when the atmospheric area to be identified is the cloud type or the fog type, which is of great significance in climate change and environmental protection.

In addition, the embodiment of the present disclosure further provides a storage medium, wherein a program for identifying a type of an atmospheric aerosol is stored on the storage medium, and when being executed by a processor, the program for identifying the type of the atmospheric aerosol implements the method for identifying the type of the atmospheric aerosol as described above.

Referring to FIG. 5, FIG. 5 is a structural block diagram of a first embodiment of an apparatus for identifying a type of an atmospheric aerosol according to the present disclosure.

As shown in FIG. 5, the apparatus for identifying the type of the atmospheric aerosol of the present disclosure includes:
a depolarization ratio determining module 501, which is configured to determine a depolarization ratio and an aerosol extinction coefficient of an atmospheric area to be identified according to a lidar signal and a relative humidity profile of the atmospheric area to be identified;
a cloud type identifying module 502, which is configured to identify a cloud type of the atmospheric area to be identified according to the lidar signal and the relative humidity profile; and
an aerosol identifying module 503, which is configured to identify a type of an atmospheric aerosol in the atmospheric area to be identified based on the cloud type, the depolarization ratio and the aerosol extinction coefficient.

It should be noted that the aerosol identifying module is further configured to identify the fog type of the atmospheric area to be identified according to the aerosol extinction coefficient when the cloud type is a cloudless type, and identify the type of the atmospheric aerosol in the atmospheric area to be identified based on the fog type and the depolarization ratio.

In this embodiment, the depolarization ratio and the aerosol extinction coefficient of the atmospheric area to be identified are determined according to the lidar signal and the relative humidity profile of the atmospheric area to be identified; thereafter, the cloud type of the atmospheric area to be identified is identified according to the lidar signal and the relative humidity profile; and then the type of the atmospheric aerosol is identified in the atmospheric area to be identified based on the cloud type, the depolarization ratio and the aerosol extinction coefficient. According to this embodiment, since a microwave radiometer is introduced while the polarized lidar is used for observation, the atmospheric temperature, the pressure, the relative humidity and the aerosol optical parameter profile can be measured synchronously, and parameter values of the area for subsequently distinguishing types of aerosols are calculated based on the lidar signal and the relative humidity profile. According to the comparison result between the parameter values and the preset reference values, the area where the atmospheric area to be identified is the cloud type is first identified. Then, the situation that the data is missing and the area is a clean area is ruled out, and the area where the atmospheric area to be identified is the fog type is identified. Finally, the type of the atmospheric aerosol except cloud and fog in the atmosphere is further identified and distinguished, so that a plurality of different types of aerosols including types of clouds, fog and other particulates in the atmosphere can be synchronously identified, a numerical determination standard is given, and the accuracy of identifying a type of an aerosol is improved.

Other embodiments or specific implementations of the device for identifying the type of the atmospheric aerosol of the present disclosure can refer to each of the above-mentioned method embodiments, which are not described in detail here.

It should be noted that in the present disclosure, the terms “including”, “containing” or any other variation thereof are intended to cover non-exclusive inclusion, so that a process, method, article or system including a series of elements includes not only those elements, but also other elements not explicitly listed, or elements inherent to such process, method, article or system. Without more restrictions, an element defined by the phrase “including a” does not exclude the presence of other identical elements in the process, method, article or system that includes the element.

The numbers of the above embodiments of the present disclosure are only for description and do not represent the advantages and disadvantages of the embodiments.

Through the description of the above embodiments, those skilled in the art can clearly understand that the method of the above embodiments can be implemented by means of software and a necessary general hardware platform, and of course can also be implemented by hardware, but in many cases, the former is a better implementation. Based on this understanding, the technical solution of the present disclosure can be embodied in the form of a software product in essence or in the part that contributes to the prior art. The computer software product is stored in a storage medium (such as a read-only memory/a random access memory, a magnetic disk, an optical disk, etc.) and includes several instructions that cause a terminal device (e.g., a mobile phone, a computer, a server, an air conditioner, or a network device, etc.) to execute the method described in various embodiments of the present disclosure.

The above is only the preferred embodiment of the present disclosure, which does not limit the patent scope of the present disclosure. Any equivalent structure or equivalent process transformation made by using the description and drawings of the present disclosure, or directly or indirectly used in other related technical fields, are equally included in the protection scope of the present disclosure.

What is claimed is:

1. A method for identifying a type of an atmospheric aerosol, comprising:
determining a depolarization ratio and an aerosol extinction coefficient of an atmospheric area to be identified according to a lidar signal and a relative humidity profile of the atmospheric area to be identified;
identifying a cloud type of the atmospheric area to be identified according to the lidar signal and the relative humidity profile; and
identifying a type of the atmospheric aerosol in the atmospheric area to be identified based on the cloud type, the depolarization ratio and the aerosol extinction coefficient.

2. The method for identifying the type of the atmospheric aerosol according to claim 1, wherein identifying the type of the atmospheric aerosol in the atmospheric area to be identified based on the cloud type, the depolarization ratio and the aerosol extinction coefficient, comprises:
identifying a fog type of the atmospheric area to be identified according to the aerosol extinction coefficient when the cloud type is a cloudless type; and
identifying the type of the atmospheric aerosol in the atmospheric area to be identified based on the fog type and the depolarization ratio.

3. The method for identifying the type of the atmospheric aerosol according to claim 2, wherein the depolarization ratio is a particulate depolarization ratio, and identifying the type of the atmospheric aerosol in the atmospheric area to be identified based on the fog type and the depolarization ratio comprises:
comparing the particulate depolarization ratio with a preset first particulate standard value when the fog type is a fogless type; and
determining that the type of the atmospheric aerosol in the atmospheric area to be identified is a dust aerosol when the depolarization ratio of the atmospheric area is greater than the preset first particulate standard value.

4. The method for identifying the type of the atmospheric aerosol according to claim 3, wherein after comparing the particulate depolarization ratio with the preset first particulate standard value when the fog type is the fogless type, the method comprises:
comparing the particulate depolarization ratio with a preset second particulate standard value when the particulate depolarization ratio is less than or equal to the preset first particulate standard value; and
determining that the type of the atmospheric aerosol in the atmospheric area to be identified is a mixed aerosol when the particulate depolarization ratio is greater than the preset second particulate standard value; or
determining that the type of the atmospheric aerosol in the atmospheric area to be identified is an artificially polluted aerosol when the particulate depolarization ratio is less than or equal to the preset second particulate standard value.

5. The method for identifying the type of the atmospheric aerosol according to claim 2, wherein after identifying the type of the atmospheric aerosol in the atmospheric area to be identified based on the fog type and the depolarization ratio, the method comprises:
when the type of the atmospheric aerosol is determined to be a particulate type, inverting a mass concentration profile of the particulate-type aerosol in the atmospheric area according to the aerosol extinction coefficient of the atmospheric area to be identified.

6. The method for identifying the type of the atmospheric aerosol according to claim 2, wherein identifying the fog type of the atmospheric area to be identified according to the aerosol extinction coefficient when the cloud type is the cloudless type, comprises:
determining whether the atmospheric area is a foggy type according to the relative humidity profile when the cloud type is the cloudless type;
comparing the aerosol extinction coefficient with a preset first fog concentration standard value when the atmospheric area is the foggy type; and
determining that the fog type of the atmospheric area to be identified is a dense fog type when the aerosol extinction coefficient is greater than the preset first fog concentration standard value; or
determining that the fog type of the atmospheric area to be identified is a mist type when the aerosol extinction coefficient is less than or equal to the preset first fog concentration standard value.

7. The method for identifying the type of atmospheric aerosol according to claim 1, wherein the depolarization ratio is an atmospheric volume depolarization ratio, and after identifying the cloud type of the atmospheric area to be identified according to the lidar signal and the relative humidity profile, the method further comprises:
comparing the atmospheric volume depolarization ratio with a preset atmospheric volume standard value when the cloud type is a cloudy type; and
determining that the cloud type of the atmospheric area to be identified is an ice cloud type when the atmospheric volume depolarization ratio is greater than the preset atmospheric volume standard value; or determining that the cloud type of the atmospheric area to be identified is a water cloud type when the atmospheric volume depolarization ratio is less than or equal to the preset atmospheric volume standard value.

8. An apparatus for identifying a type of an atmospheric aerosol, comprising:
a depolarization ratio determining module configured to determine a depolarization ratio and an aerosol extinction coefficient of an atmospheric area to be identified according to a lidar signal and a relative humidity profile of the atmospheric area to be identified;
a cloud type identifying module configured to identify a cloud type of the atmospheric area to be identified according to the lidar signal and the relative humidity profile; and
an aerosol identifying module configured to identify the type of the atmospheric aerosol in the atmospheric area to be identified based on the cloud type, the depolarization ratio and the aerosol extinction coefficient.

9. A device for identifying a type of an atmospheric aerosol, comprising:
a memory, a processor, and a program for identifying the type of the atmospheric aerosol stored in the memory and operable on the processor, wherein the program for identifying the type of the atmospheric aerosol is configured to implement the method for identifying the type of the atmospheric aerosol according to claim 1.

10. The device according to claim 9, wherein identifying the type of the atmospheric aerosol in the atmospheric area to be identified based on the cloud type, the depolarization ratio and the aerosol extinction coefficient, comprises:
identifying a fog type of the atmospheric area to be identified according to the aerosol extinction coefficient when the cloud type is a cloudless type; and
identifying the type of the atmospheric aerosol in the atmospheric area to be identified based on the fog type and the depolarization ratio.

11. The device according to claim 10, wherein the depolarization ratio is a particulate depolarization ratio, and identifying the type of the atmospheric aerosol in the atmospheric area to be identified based on the fog type and the depolarization ratio comprises:
comparing the particulate depolarization ratio with a preset first particulate standard value when the fog type is a fogless type; and
determining that the type of the atmospheric aerosol in the atmospheric area to be identified is a dust aerosol when the depolarization ratio of the atmospheric area is greater than the preset first particulate standard value.

12. The device according to claim 11, wherein after comparing the particulate depolarization ratio with the preset first particulate standard value when the fog type is the fogless type, the method comprises:
comparing the particulate depolarization ratio with a preset second particulate standard value when the particulate depolarization ratio is less than or equal to the preset first particulate standard value; and
determining that the type of the atmospheric aerosol in the atmospheric area to be identified is a mixed aerosol when the particulate depolarization ratio is greater than the preset second particulate standard value; or
determining that the type of the atmospheric aerosol in the atmospheric area to be identified is an artificially polluted aerosol when the particulate depolarization ratio is less than or equal to the preset second particulate standard value.

13. The device according to claim 10, wherein after identifying the type of the atmospheric aerosol in the atmospheric area to be identified based on the fog type and the depolarization ratio, the method comprises:
when the type of the atmospheric aerosol is determined to be a particulate type, inverting a mass concentration profile of the particulate-type aerosol in the atmospheric area according to the aerosol extinction coefficient of the atmospheric area to be identified.

14. The device according to claim 10, wherein identifying the fog type of the atmospheric area to be identified according to the aerosol extinction coefficient when the cloud type is the cloudless type, comprises:
determining whether the atmospheric area is a foggy type according to the relative humidity profile when the cloud type is the cloudless type;
comparing the aerosol extinction coefficient with a preset first fog concentration standard value when the atmospheric area is the foggy type; and
determining that the fog type of the atmospheric area to be identified is a dense fog type when the aerosol extinction coefficient is greater than the preset first fog concentration standard value; or
determining that the fog type of the atmospheric area to be identified is a mist type when the aerosol extinction coefficient is less than or equal to the preset first fog concentration standard value.

15. A storage medium, wherein a program for identifying a type of atmospheric aerosol is stored on the storage medium, and when being executed by a processor, the program performs the method for identifying the type of the atmospheric aerosol according to claim 1.

16. A storage medium according to claim 15, wherein identifying the type of the atmospheric aerosol in the atmospheric area to be identified based on the cloud type, the depolarization ratio and the aerosol extinction coefficient, comprises:
identifying a fog type of the atmospheric area to be identified according to the aerosol extinction coefficient when the cloud type is a cloudless type; and
identifying the type of the atmospheric aerosol in the atmospheric area to be identified based on the fog type and the depolarization ratio.

17. A storage medium according to claim 16, wherein the depolarization ratio is a particulate depolarization ratio, and identifying the type of the atmospheric aerosol in the atmospheric area to be identified based on the fog type and the depolarization ratio comprises:
comparing the particulate depolarization ratio with a preset first particulate standard value when the fog type is a fogless type; and
determining that the type of the atmospheric aerosol in the atmospheric area to be identified is a dust aerosol when the depolarization ratio of the atmospheric area is greater than the preset first particulate standard value.

18. A storage medium according to claim 17, wherein after comparing the particulate depolarization ratio with the preset first particulate standard value when the fog type is the fogless type, the method comprises:
comparing the particulate depolarization ratio with a preset second particulate standard value when the particulate depolarization ratio is less than or equal to the preset first particulate standard value; and
determining that the type of the atmospheric aerosol in the atmospheric area to be identified is a mixed aerosol when the particulate depolarization ratio is greater than the preset second particulate standard value; or
determining that the type of the atmospheric aerosol in the atmospheric area to be identified is an artificially polluted aerosol when the particulate depolarization ratio is less than or equal to the preset second particulate standard value.

19. A storage medium according to claim 16, wherein after identifying the type of the atmospheric aerosol in the atmospheric area to be identified based on the fog type and the depolarization ratio, the method comprises:
when the type of the atmospheric aerosol is determined to be a particulate type, inverting a mass concentration profile of the particulate-type aerosol in the atmospheric area according to the aerosol extinction coefficient of the atmospheric area to be identified.

20. A storage medium according to claim 16, wherein identifying the fog type of the atmospheric area to be identified according to the aerosol extinction coefficient when the cloud type is the cloudless type, comprises:
determining whether the atmospheric area is a foggy type according to the relative humidity profile when the cloud type is the cloudless type;
comparing the aerosol extinction coefficient with a preset first fog concentration standard value when the atmospheric area is the foggy type; and
determining that the fog type of the atmospheric area to be identified is a dense fog type when the aerosol extinction coefficient is greater than the preset first fog concentration standard value; or
determining that the fog type of the atmospheric area to be identified is a mist type when the aerosol extinction coefficient is less than or equal to the preset first fog concentration standard value.
